(19) United States
(12) Patent Application Publication
(10) Pub. No.: US 2026/0107194 A1
(43) Pub. Date: Apr. 16, 2026

(54) PER-FREQUENCY RANGE MEASUREMENT GAP INDICATION WITH ADAPTED REPORTING

(71) Applicant: Apple Inc., Cupertino, CA (US)

(72) Inventors: Xiang Chen, Campbell, CA (US); Jie Cui, San Jose, CA (US); Rolando E. Bettancourt Ortega, Munich, Bavaria-Bayern (DE); Yang Tang, San Jose, CA (US); Dawei Zhang, Saratoga, CA (US); Qiming Li, Beijing (CN); Haitong Sun, Cupertino, CA (US); Manasa Raghavan, Sunnyvale, CA (US); Yuexia Song, Beijing (CN)

(21) Appl. No.: 19/112,350

(22) PCT Filed: Sep. 30, 2022
(86) PCT No.: PCT/CN2022/123053

§ 371 Date: Mar. 17, 2025

(51) Int. Cl. H04W 36/00; H04W 24/10

(52) U.S. Cl. CPC H04W 36/00692; H04W 24/10

(57) ABSTRACT

A user equipment (UE) includes a set of transceivers and a processor. The processor is configured to transmit a first indication that the UE is capable of supporting per-frequency range (FR) measurement gap configurations. In some examples, the processor may identify that multiple bands associated with a first FR are configured based at least in part on one or more NR carrier aggregation (CA) or multi-RAT dual connectivity (MR-DC) configurations for the UE. The processor may receive a configuration for a measurement object in a second FR different from the first FR. The processor may transmit a second indication for a gap measurement exception associated with the per-FR measurement gap DL configuration based at least in part on the reception of the measurement object.

### TECHNICAL FIELD

This application relates generally to wireless communication systems, including measurement gap configurations and framework.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communications system including a UE and a base station, including an example of a measurement gap configuration.

FIG. 2 shows a first example method of wireless communication by a UE.

FIG. 3 shows a second example method of wireless communication by a UE.

FIG. 4. shows a third example method of wireless communication by a UE.

FIG. 5 illustrates an example architecture of a wireless communication system, according to embodiments disclosed herein.

FIG. 6 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

In a 3GPP network, for example with respect to NR Release 15, there may be two measurement gap configurations defined based on UE capability. A first measurement gap configuration may correspond to a per-UE measurement gap and a second measurement gap configuration may correspond to a per-frequency range (FR) measurement gap configuration. Measurement gaps may be required if a UE is requested to perform measurements which cannot be completed while the UE is tuned to one or more cells. That is, measurement gaps may impact performance because the measurement operations may interrupt uplink (UL) or downlink (DL) data transmissions.

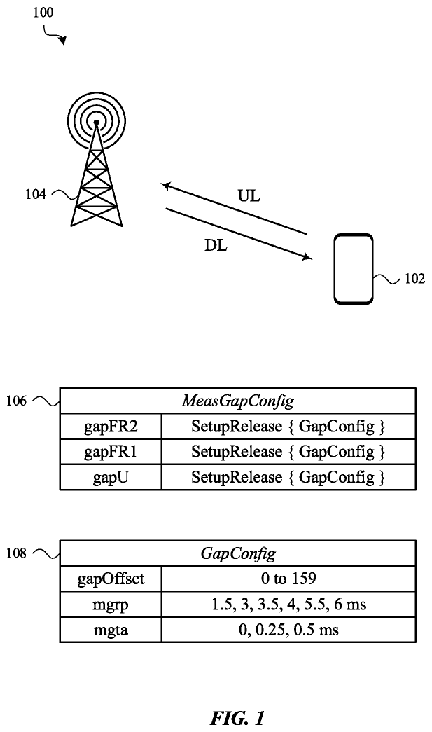

FIG. 1 shows an example wireless communications system 100 including a UE 102 and base station 104. The UE 102 may communicate with the base station on a DL and an UL. In various embodiments, the UE 102 may communicate with the base station 104 regarding measurement gaps (e.g., capabilities and configurations). In some embodiments, the UE 102 may receive a measurement gap configuration 106 via radio resource control (RRC) signaling. For example, measurement gaps may be configured using a parameter structure specified in NR Release 15. In some cases, a measurement gap pattern can be configured for both Frequency Range 1 (FR1) and Frequency Range 2 (FR2). In some cases, rather than a single measurement pattern (e.g., ‘gapUE’), different measurement gap patterns may be configured for different FRs. For example, a first measurement gap pattern may be configured for FR1 (e.g., ‘gapFR1’) and a second measurement gap pattern may be configured for FR2 (e.g., ‘gapFR2’). Each of ‘gapUE’, ‘gapFR1’, and ‘gapFR2’ may have a corresponding gap configuration 108. For example, measurement gaps may start during radio frames and subframes in accordance with a measure gap repetition period (mgrp) and a gapOffset. A duration of each measurement gap may be configured using a measurement gap length (mgl). In some cases, a measurement gap timing advance (mgta) may be configured to advance the timing of the measurement gap, for example, to improve the alignment between the measurement gaps and the SS/PBCH block measurement time configuration (SMTC).

In a per-UE measurement gap configuration, the radio frequency (RF) and/or baseband resources are assumed to be shared between FRs used by the UE. That is, for example, the UE may operate in both FR1 (i.e., a FR having a corresponding FR of 410 MHz-7125 MHz) and FR2 (i.e., a FR having a corresponding FR of 24250 MHz-52600 MHZ). As such, by sharing radio frequency and/or baseband resources in a per-UE measurement gap configuration, performing gap measurement based on a measurement object in support of either one of FR1 or FR2 is not an independent operation as resources used for the measurement object and gap measurement in support of one of the FRs may impact data transmissions in the other FR.

By contrast, in a per-FR gap measurement gap configuration, separate RF and/or baseband resources are provisioned between FRs (e.g., between FR1 and FR2). Because radio frequency and/or baseband resources in a per-FR measurement gap configuration are separately provisioned, performing gap measurement based on a measurement object in support of either one of FR1 or FR2 will typically not impact data transmissions in the other FR. The per-FR gap measurement gap configuration may be considered a more complex configuration as the UE provisions separate RF and/or baseband resources for each of FR1 and FR2. However, per-FR measurement gap configurations may have an advantage as compared to per-UE measurement gap configurations, because measurement in one FR (e.g., FR1) will typically not impact the data transmission and reception in the other FR (e.g., FR2).

When a UE indicates to the network that it supports per-FR measurement gaps, the UE is expected to support the per-FR measurement gap for all of the NR carrier aggregation (CA) or multi-RAT dual connectivity (MR-DC) band combinations (e.g., next generation (NG) EUTRA-NR dual connectivity EN-DC), NR dual connectivity (NR-DC), NR-EUTRA dual connectivity (NE-DC)). For example, if a UE is operating in a CA mode that includes one or more component carriers (CCs) in FR1 and one or more CCs in FR2, as discussed above, performing gap measurement according to a per-FR measurement gap configuration may, for instance, temporarily impact the data transmissions on the one or more CCs in FR2, but it would not impact the data transmissions on the one or more CCs in FR1. However, rather than solely indicating a FR for per-FR gap measurement, in some cases, it may be beneficial to consider a measurement gap configuration for specific band combinations. That is, for example, a per-band combination (per-BC) indication may be added to per-FR measurement gap configurations. In some CA cases, the position of a band combination may be indicated to the UE. For example, a band combination may be referred to by an index which corresponds to the position of the band combination for a list of supported band combinations by the UE.

A per-BC indication for performing gap measurements may implicate RF and/or baseband resources in each of FR1 and FR2. Additionally, some band combinations may be configured with a large number of CCs in one of the FRs, and the UE may be required to utilize RF and/or baseband resources provisioned for the other FR in order to accommodate the gap measurement for the large number of CCs. Accordingly, it may be beneficial to allow the UE some exceptions in performing gap measurement with respect to some band combinations, even though the UE had indicated support for a per-FR measurement gap configuration. For example, if the UE has a high order CA configuration (e.g., a large number of CCs configured) in a single FR (e.g., in FR1), when the UE needs to perform a gap measurement in FR2, the UE is still required to support FR2 data transmission and reception. However, in some cases, with 10 CCs configured for a high order CA configuration in FR1, the UE will likely not be able to support gap measurement in FR2 at the same time due to a lack of RF and/or baseband resources. By contrast, in some cases, with 9 or fewer CCs configured for a high order CA configuration in FR1, the UE will likely be able to support gap measurement in FR2 without impacting the data transmission and reception in FR1.

That is, for example, the per-FR measurement gap configuration and UE support thereof is to be considered jointly with a per-band combination (BC) indication to account for the varied complexity (e.g., larger number of CCs and/or wider bandwidths of each CC) for some band combinations. In some cases, a 3GPP NR Release 16 NeedforGap framework may be used to accommodate per-BC indications associated with a per-FR measurement gap configuration. The UE must indicate to the network UE capability in support of a NeedforGap framework. That is, for example, the UE indicates UE capability for “nr-NeedForGap-Reporting-r16” via RRC signaling. The network may indicate measurement objects for band combinations that the UE may use. The UE may then use the “NeedForGapsInfoNR-r16” information element to indicate to the network whether, for measurement on a particular band combination, a measurement gap is needed or not needed (e.g., a per-BC indication of support corresponding to various per-FR measurement gap configurations).

While some exceptions to per-FR gap measurement (e.g., for certain high order CA scenarios) may be warranted, for optimized network performance, such exceptions should be limited. The UE may indicate support for a per-FR gap to the network. In some embodiments, the NeedforGap framework is to be used to indicate that a per-FR gap measurement is not feasible under certain conditions.

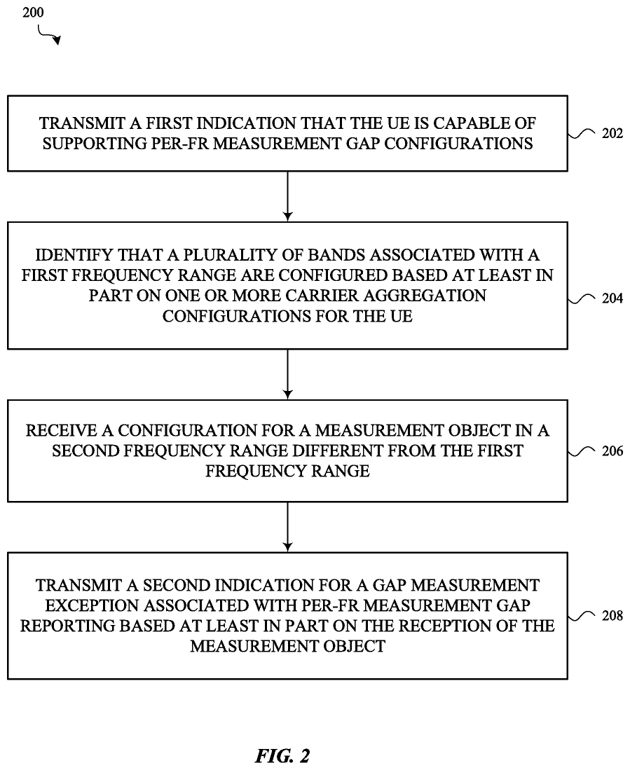

FIG. 2 shows a first example method 200 of wireless communication by a UE. The method 200 may be performed by the UE described with reference to FIG. 1 or by other UEs described herein. The method 200 may be performed using a processor, a set of transceivers (e.g., one or more transceivers), or other components of a UE.

At 202, the method 200 may include transmitting a first indication that the UE is capable of supporting a per-FR measurement gap configuration.

At 204, the method 200 may include identifying that a plurality of bands associated with a first FR are configured based at least in part on one or more NR CA or MR-DC configurations for the UE. In some embodiments of the method 200, the plurality of bands associated with the first FR may include all assignable bands in the FR.

At 206, the method 200 may include receiving a configuration for a measurement object in a second FR different from the first FR.

At 208, the method 200 may include transmitting a second indication for a gap measurement exception associated with the per-FR measurement gap configuration based at least in part on the reception of the measurement object.

The method 200 may be variously embodied, extended, or adapted, as described in the following paragraphs and elsewhere in this description.

In some embodiments, for example, a UE operating in accordance with aspects of the method 200 may receive one or more carrier configurations that configure all assignable bands in a particular FR (e.g., FR1). Then, for example, if the UE receives a configuration for a measurement object, in some embodiments of the method 200, the measurement object may correspond to a band combination in FR2, for which the UE would otherwise perform the gap measurement based on the indication that the UE supports per-FR gap measurement reporting if the plurality of bands (e.g., all assignable bands) in FR1 were not configured at the time when the measurement object was sent by the network.

Non-limiting examples of NR CA or MR-DC configurations may include, for example, NG EN-DC, NR-DC, and NE-DC. Additionally or alternatively, in some embodiments of the method 200, other carrier configurations may be used to configure the UE.

In some embodiments of the method 200, a band as used herein refers to an NR operating band within a particular FR. Non-limiting examples of NR operating bands may include, for example, n257, n258, n259, n260, and n261, each of which may have a subcarrier spacing (SCS) of a corresponding synchronization signal block (SSB) of 120 kHz.

In some embodiments of the method 200, the first indication may be associated with a transmission of an ‘independentGapConfig’ information element. In some embodiments of the method 200, the first FR corresponds to FR1 defined for a 3GPP NR network. In some embodiments of the method 200, the second FR corresponds to FR2 defined for the 3GPP NR network.

Additionally or alternatively, in some embodiments, the method 200 may include transmitting a third indication that the UE is capable of supporting a reporting measurement gap information framework for NR responsive to a network configuration message. In some cases, the third indication may be associated with a transmission of an ‘nr-NeedForGap-Reporting’(e.g., ‘nr-NeedForGap-Reporting-r16’ for 3GPP NR Release 16) information element. In some cases, the reporting measurement gap information framework may be associated with a NeedforGap framework for NR.

In some embodiments of the method 200, the second indication may be associated with a transmission of a ‘NeedForGapsInfoNR’ (e.g., ‘NeedForGapsInfoNR-r16’ for 3GPP NR Release 16) information element. That is, for example, the list of band combinations to be included in the ‘NeedForGapsInfoNR’ information element may omit the band combination for which the UE received the measurement object. In other words, the UE may request an exception indicating that the UE cannot or desires not to support per-FR gap measurement at the current time.

In some embodiments of the method 200, the one or more NR CA or MR-DC configurations may be received via RRC signaling. In some embodiments of the method 200, the one or more NR CA or MR-DC configurations may be received via other signaling, such as but not limited to medium access control (MAC) control element (CE) (MAC CE).

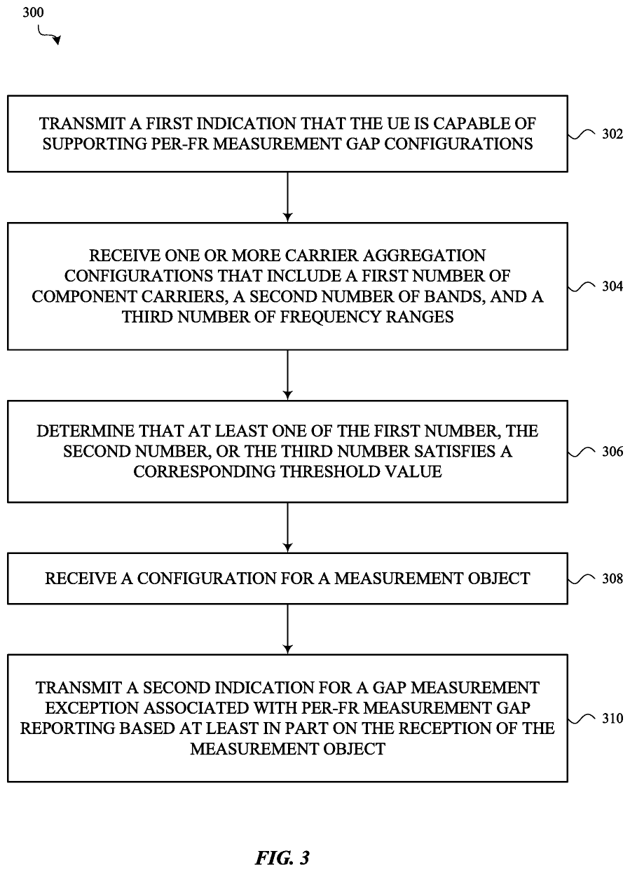

FIG. 3 shows a second example method 300 of wireless communication by a UE. The method 300 may be performed by the UE described with reference to FIG. 1 or by other UEs described herein. The method 300 may be performed using a processor, a set of transceivers (e.g., one or more transceivers), or other components of a UE.

At 302, the method 300 may include transmitting a first indication that the UE is capable of supporting a per-FR measurement gap configuration.

At 304, the method 300 may include receiving one or more NR CA or MR-DC configurations that include a first number of component carriers, a second number of bands, and a third number of FRs.

At 306, the method 300 may include determining that at least one of the first number, the second number, or the third number satisfies a corresponding threshold value.

At 308, the method 300 may include receiving a configuration for a measurement object.

At 310, the method 300 may include transmitting a second indication for a gap measurement exception associated with the per-FR measurement gap configuration based at least in part on the reception of the measurement object.

The method 300 may be variously embodied, extended, or adapted, as described in the following paragraphs and elsewhere in this description.

In some embodiments, for example, a UE operating in accordance with aspects of the method 300 may determine when one or more thresholds associated with a configured band combination are satisfied. Then, for example, when the UE receives a measurement objective corresponding to the configured band combination, the UE may utilize the NeedforGap framework to indicate that performing per-FR gap measurement may not be feasible for that configured band combination.

In some embodiments of the method 300, threshold values corresponding to the first number of component carriers, the second number of bands, and the third number of FRs may be referred to as N (e.g., a threshold value of component carriers), M (e.g., a threshold value of bands), and O (e.g., a threshold value of FRs).

In some embodiments of the method 300, the values of N, M, and O may be predefined values. For example, the values of N, M, and O may be hardcoded (e.g., with respect to a particular 3GPP standard and/or standards release) and signaled by the network. In some embodiments of the method 300, the UE behavior may be such that the values of N, M, and O are known a priori by the UE. In some embodiments of the method 300, the values of N, M, and O may be transmitted via RRC signaling. In some embodiments of the method 300, the UE may determine the values of N, M, and O, and then provide or suggest these values to the network via a UE capabilities report. In some embodiments of the method 300, the values of N, M, and O may be known by the network based on a type of UE that is connected to the network. That is, for example, various UEs and devices may have different levels of complexity and processing capabilities, for instance, depending on the specific deployment or implementation. As such, the values of N, M, and O may correspondingly differ in various embodiments.

Additionally or alternatively, in some embodiments, the method 300 may include receiving at least one of a first threshold value (e.g., M) corresponding to component carriers, a second threshold value (e.g., N) corresponding to bands, or a third threshold value (e.g., O) corresponding to FRs. In some embodiments of the method 300, when at least one of these thresholds is satisfied in a configured band combination, the UE may utilize the NeedforGap framework to indicate that performing per-FR gap measurement may not be feasible for that configured band combination.

Additionally or alternatively, in some embodiments, the method 300 may include transmitting at least one of a first threshold value (e.g., M) corresponding to component carriers, a second threshold value (e.g., N) corresponding to bands, or a third threshold value (e.g., O) corresponding to FRs.

In some embodiments of the method 300, the at least one of the first threshold value (e.g., M), the second threshold value (e.g., N), or the third threshold value (e.g., O) is a transmission associated with UE capability reporting.

In some embodiments of the method 300, the corresponding threshold value (e.g., M) comprises a first threshold value (e.g., M1) corresponding to component carriers in a first FR (e.g., FR1) or a second threshold value (e.g., M2) corresponding to component carriers in a second FR (e.g., FR2). That is, for example, different values of M may exist for different FRs.

Additionally or alternatively, in some embodiments of the method 300, different values of N may exist for different FRs. That is, for example, the corresponding threshold value (e.g., N) may comprise a first threshold value (e.g., N1) corresponding to bands in a first FR (e.g., FR1) or a second threshold value (e.g., N2) corresponding to bands in a second FR (e.g., FR2).

Additionally or alternatively, in some embodiments, the method 300 may include determining that a second one of the first number, the second number, or the third number satisfies a corresponding second threshold value. For example, the method 300 may determine that a first one of the first number, the second number, or the third number (e.g., the third number of FRs) satisfies a corresponding threshold value (e.g., O), and may also determine that a second one of the first number, the second number, or the third number (e.g., the second number of bands) satisfies a corresponding second threshold value (e.g., N). That is, for example, the corresponding threshold value (e.g., O) for the at least one (e.g., the third number of FRs) of the first number, the second number, or the third number is different from the corresponding second threshold value (e.g., N) for the second one (e.g., the second number of bands) of the first number, the second number, or the third number.

Additionally or alternatively, in some embodiments, the method 300 may include identifying that a plurality of bands associated with a first FR are configured based at least in part on the one or more NR CA or MR-DC configurations for the UE. In some embodiments, the plurality of bands associated with the first FR may include all assignable bands in the FR. In some embodiments of the method 300, determining that the at least one of the first number, the second number, or the third number satisfies the corresponding threshold value may comprise determining that at least one of the first number or the second number satisfies the corresponding threshold value (e.g., M or N).

In some embodiments of the method 300, the second indication for the gap measurement exception associated with the per-FR measurement gap configuration is based at least in part on the corresponding threshold value being satisfied. In some embodiments of the method 300, the second indication for the gap measurement exception associated with the per-FR measurement gap configuration is based at least in part on the a number of baseband resources being used by the UE.

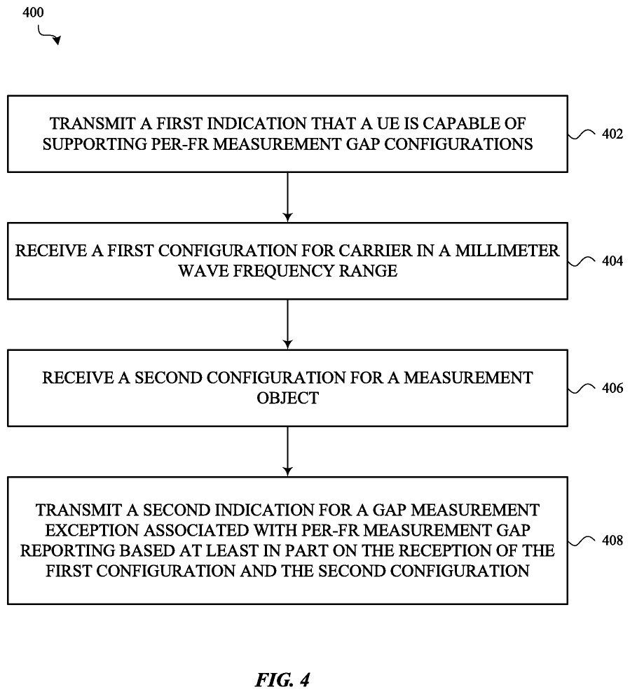

FIG. 4 shows a third example method 400 of wireless communication by a UE. The method 400 may be performed by the UE described with reference to FIG. 1 or by other UEs described herein. The method 400 may be performed using a processor, a set of transceivers (e.g., one or more transceivers), or other components of a UE.

At 402, the method 400 may include transmitting a first indication that the UE is capable of supporting a per-FR measurement gap configuration.

At 404, the method 400 may include receiving a first configuration for a carrier in a millimeter wave FR.

At 406, the method 400 may include receiving a second configuration for a measurement object.

At 408, the method 400 may include transmitting a second indication for a gap measurement exception associated with the per-FR measurement gap configuration based at least in part on the reception of the first configuration and the second configuration.

The method 400 may be variously embodied, extended, or adapted, as described in the following paragraphs and elsewhere in this description.

In some embodiments of the method 400, the NeedforGap framework is to be used to indicate that a per-FR gap measurement is not feasible upon configuration of a band combination in FR2-2 or configuration of a measurement object in FR2-2. That is, for example, given the larger channel bandwidth used in FR2-2, a significant amount of baseband resources are used by the UE. As such, in some embodiments of the method 400, the UE may utilize the NeedforGap framework combination to indicate that performing per-FR gap measurement is not feasible for the band combination configured in FR2-2 or a band combination configured in a FR different from FR2-2 when a measurement object is configured in FR2-2. In some embodiments, FR2-2 is defined as a millimeter wave (mmWave) FR, for example, having a corresponding FR of 52.6-71 GHz.

Embodiments contemplated herein include an apparatus having means to perform one or more elements of the method 200, 300, or 400. In the context of method 200, 300, or 400, the apparatus may be, for example, an apparatus of a UE (such as a wireless device 602 that is a UE, as described herein). As would be apparent given the benefit of the disclosure and embodiments described herein, in the complementary context of method 200, 300, or 400, the apparatus may be, for example, an apparatus of a base station (such as a network device 620 that is a base station, as described herein).

Embodiments contemplated herein include one or more non-transitory computer-readable media storing instructions to cause an electronic device, upon execution of the instructions by one or more processors of the electronic device, to perform one or more elements of the method 200, 300, or 400. In the context of method 200, 300, or 400, the non-transitory computer-readable media may be, for example, a memory of a UE (such as a memory 606 of a wireless device 602 that is a UE, as described herein). As would be apparent given the benefit of the disclosure and embodiments described herein, in the complementary context of method 200, 300, or 400, the non-transitory computer-readable media may be, for example, a memory of a base station (such as a memory 624 of a network device 620 that is a base station, as described herein).

Embodiments contemplated herein include an apparatus having logic, modules, or circuitry to perform one or more elements of the method 200, 300, or 400. In the context of method 200, 300, or 400, the apparatus may be, for example, an apparatus of a UE (such as a wireless device 602 that is a UE, as described herein). As would be apparent given the benefit of the disclosure and embodiments described herein, in the complementary context of method 200, 300, or 400, the apparatus may be, for example, an apparatus of a base station (such as a network device 620 that is a base station, as described herein).

Embodiments contemplated herein include an apparatus having one or more processors and one or more computer-readable media, using or storing instructions that, when executed by the one or more processors, cause the one or more processors to perform one or more elements of the method 200, 300, or 400. In the context of method 200, 300, or 400, the apparatus may be, for example, an apparatus of a UE (such as a wireless device 602 that is a UE, as described herein). As would be apparent given the benefit of the disclosure and embodiments described herein, in the complementary context of method 200, 300, or 400, the apparatus may be, for example, an apparatus of a base station (such as a network device 620 that is a base station, as described herein).

Embodiments contemplated herein include a signal as described in or related to one or more elements of the method 200, 300, or 400.

Embodiments contemplated herein include a computer program or computer program product having instructions, wherein execution of the program by a processor causes the processor to carry out one or more elements of the methods 200, 300, or 400. In the context of method 200, 300, or 400, the processor may be a processor of a UE (such as a processor(s) 604 of a wireless device 602 that is a UE, as described herein), and the instructions may be, for example, located in the processor and/or on a memory of the UE (such as a memory 606 of a wireless device 602 that is a UE, as described herein). As would be apparent given the benefit of the disclosure and embodiments described herein, in the complementary context of method 200, 300, or 400, the processor may be a processor of a base station (such as a processor(s) 622 of a network device 620 that is a base station, as described herein), and the instructions may be, for example, located in the processor and/or on a memory of the base station (such as a memory 624 of a network device 620 that is a base station, as described herein).

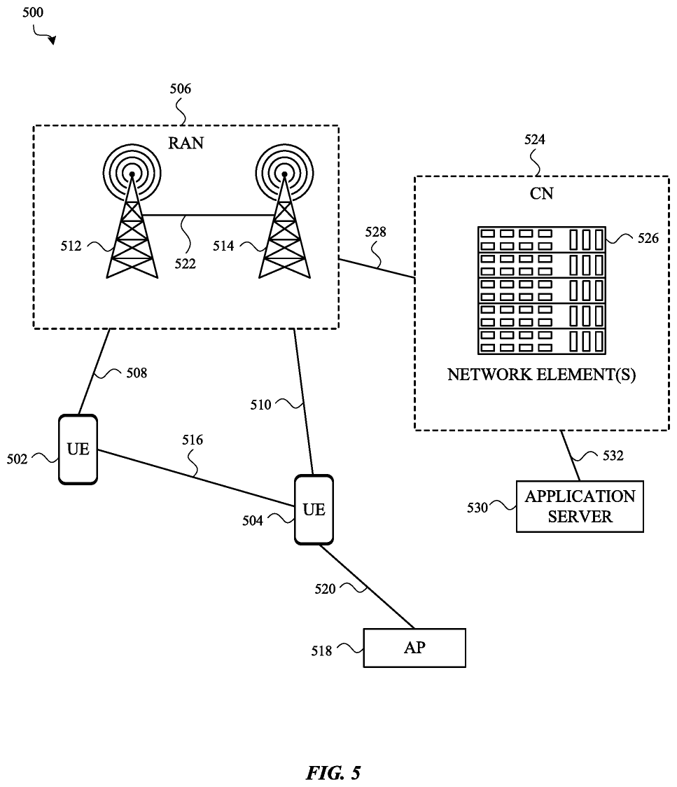

FIG. 5 illustrates an example architecture of a wireless communication system 500, according to embodiments disclosed herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also comprise any mobile or non-mobile computing device configured for wireless communication.

The UE 502 and UE 504 may be configured to communicatively couple with a RAN 506. In embodiments, the RAN 506 may be NG-RAN, E-UTRAN, etc. The UE 502 and UE 504 utilize connections (or channels) (shown as connection 508 and connection 510, respectively) with the RAN 506, each of which comprises a physical communications interface. The RAN 506 can include one or more base stations, such as base station 512 and base station 514, that enable the connection 508 and connection 510.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can comprise a local wireless connection, such as a connection consistent with any IEEE 802.11 protocol, wherein the AP 518 may comprise a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 500 is an LTE system (e.g., when the CN 524 is an EPC), the interface 522 may be an X2 interface. The X2 interface may be defined between two or more base stations (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more base stations (e.g., two or more gNBs and the like) that connect to 5GC, between a base station 512 (e.g., a gNB) connecting to 5GC and an eNB, and/or between two eNBs connecting to 5GC (e.g., CN 524).

The RAN 506 is shown to be communicatively coupled to the CN 524. The CN 524 may comprise one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an S1 interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the S1 control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VoIP sessions, group communication sessions, etc.) for the UE 502 and UE 504 via the CN 524. The application server 530 may communicate with the CN 524 through an IP communications interface 532.

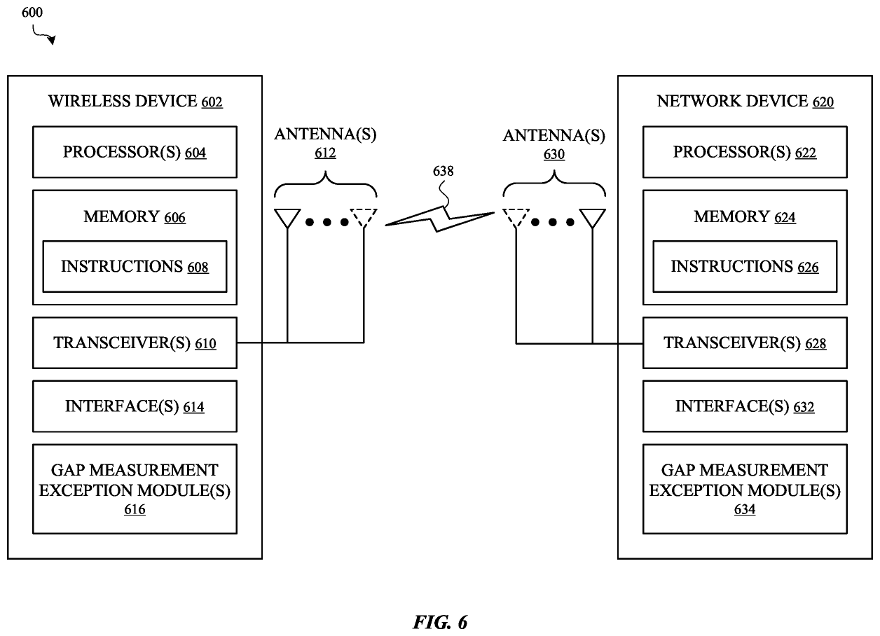

FIG. 6 illustrates a system 600 for performing signaling 638 between a wireless device 602 and a network device 620, according to embodiments disclosed herein. The system 600 may be a portion of a wireless communications system as herein described. The wireless device 602 may be, for example, a UE of a wireless communication system. The network device 620 may be, for example, a base station (e.g., an eNB or a gNB) of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter and/or receiver circuitry that use the antenna(s) 612 of the wireless device 602 to facilitate signaling (e.g., the signaling 638) to and/or from the wireless device 602 with other devices (e.g., the network device 620) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include a gap measurement exception module 616. The gap measurement exception module 616 may be implemented via hardware, software, or combinations thereof. For example, the gap measurement exception module 616 may be implemented as a processor, circuit, and/or instructions 608 stored in the memory 606 and executed by the processor(s) 604. In some examples, the gap measurement exception module 616 may be integrated within the processor(s) 604 and/or the transceiver(s) 610. For example, the gap measurement exception module 616 may be implemented by a combination of software components (e.g., executed by a DSP or a general processor) and hardware components (e.g., logic gates and circuitry) within the processor(s) 604 or the transceiver(s) 610.

The gap measurement exception module 616 may be used for various aspects of the present disclosure, for example, aspects of FIG. 1 through FIG. 4. The gap measurement exception module 616 may be configured to, for example, receive, determine, and/or apply measurement gap configurations and framework received from another device (e.g., the network device 620) and/or determined locally at the wireless device 602.

The network device 620 may include one or more processor(s) 622. The processor(s) 622 may execute instructions such that various operations of the network device 620 are performed, as described herein. The processor(s) 622 may include one or more baseband processors implemented using, for example, a CPU, a DSP, an ASIC, a controller, an FPGA device, another hardware device, a firmware device, or any combination thereof configured to perform the operations described herein.

The network device 620 may include a memory 624. The memory 624 may be a non-transitory computer-readable storage medium that stores instructions 626 (which may include, for example, the instructions being executed by the processor(s) 622). The instructions 626 may also be referred to as program code or a computer program. The memory 624 may also store data used by, and results computed by, the processor(s) 622.

The network device 620 may include one or more transceiver(s) 628 that may include RF transmitter and/or receiver circuitry that use the antenna(s) 630 of the network device 620 to facilitate signaling (e.g., the signaling 638) to and/or from the network device 620 with other devices (e.g., the wireless device 602) according to corresponding RATs.

The network device 620 may include one or more antenna(s) 630 (e.g., one, two, four, or more). In embodiments having multiple antenna(s) 630, the network device 620 may perform MIMO, digital beamforming, analog beamforming, beam steering, etc., as has been described.

The network device 620 may include one or more interface(s) 632. The interface(s) 632 may be used to provide input to or output from the network device 620. For example, a network device 620 that is a base station may include interface(s) 632 made up of transmitters, receivers, and other circuitry (e.g., other than the transceiver(s) 628 and antenna(s) 630 already described) that enables the base station to communicate with other equipment in a core network, and/or that enables the base station to communicate with external networks, computers, databases, and the like for purposes of operations, administration, and maintenance of the base station or other equipment operably connected thereto.

The network device 620 may include a gap measurement exception module 634. The gap measurement exception module 634 may be implemented via hardware, software, or combinations thereof. For example, the gap measurement exception module 634 may be implemented as a processor, circuit, and/or instructions 626 stored in the memory 624 and executed by the processor(s) 622. In some examples, the gap measurement exception module 634 may be integrated within the processor(s) 622 and/or the transceiver(s) 628. For example, the gap measurement exception module 634 may be implemented by a combination of software components (e.g., executed by a DSP or a general processor) and hardware components (e.g., logic gates and circuitry) within the processor(s) 622 or the transceiver(s) 628.

The gap measurement exception module 634 may be used for various aspects of the present disclosure, for example, aspects of FIG. 1 through FIG. 4. The gap measurement exception module 634 may be configured to, for example, determine or transmit measurement gap configurations to another device (e.g., the wireless device 602).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
one or more transceivers; and
a processor configured to,
transmit, via the one or more transceivers, a first indication that the UE is capable of supporting a per-frequency range (FR) measurement gap configuration;
identify that a plurality of bands associated with a first FR are configured based at least in part on one or more NR carrier aggregation (CA) or multi-RAT dual connectivity (MR-DC) configurations for the UE;
receive, via the one or more transceivers, a configuration for a measurement object in a second FR different from the first FR; and
transmit, via the one or more transceivers, a second indication for a gap measurement exception associated with the per-FR measurement gap configuration based at least in part on the reception of the measurement object.

2. The UE of claim 1, wherein the first indication is associated with a transmission of an independentGapConfig information element.

3. The UE of claim 1, wherein:
the first FR corresponds to FR1 defined for a 3GPP NR network; and
the second FR corresponds to FR2 defined for the 3GPP NR network.

4. The UE of claim 1, wherein the processor is configured to transmit, via the one or more transceivers, a third indication that the UE is capable of supporting a reporting measurement gap information framework for NR responsive to a network configuration message.

5. The UE of claim 4, wherein:
the third indication is associated with a transmission of an nr-NeedForGap-Reporting information element; and
the reporting measurement gap information framework is associated with a NeedforGap framework for NR.

6. The UE of claim 1, wherein the second indication is associated with a transmission of a NeedForGapsInfoNR information element.

7. The UE of claim 1, wherein the one or more NR CA or MR-DC configurations are received via radio resource control (RRC) signaling.

8. A user equipment (UE), comprising:
one or more transceivers; and
a processor configured to,
transmit, via the one or more transceivers, a first indication that the UE is capable of supporting per-frequency range (FR) measurement gap configurations;
receive, via the one or more transceivers, one or more NR carrier aggregation (CA) or multi-RAT dual connectivity (MR-DC) configurations that include a first number of component carriers, a second number of bands, and a third number of FRs;
determine that at least one of the first number, the second number, or the third number satisfies a corresponding threshold value;
receive, via the one or more transceivers, a configuration for a measurement object; and
transmit, via the one or more transceivers, a second indication for a gap measurement exception associated with the per-FR measurement gap configuration based at least in part on the reception of the measurement object.

9. The UE of claim 8, wherein the processor is configured to receive, via the one or more transceivers, at least one of a first threshold value corresponding to component carriers, a second threshold value corresponding to bands, or a third threshold value corresponding to FRs.

10. The UE of claim 8, wherein the processor is configured to transmit, via the one or more transceivers, at least one of a first threshold value corresponding to component carriers, a second threshold value corresponding to bands, or a third threshold value corresponding to FRs.

11. The UE of claim 10, wherein the at least one of the first threshold value, the second threshold value, or the third threshold value is a transmission associated with UE capability reporting.

12. The UE of claim 8, wherein:
the corresponding threshold value comprises a first threshold value corresponding to component carriers in a first FR or a second threshold value corresponding to component carriers in a second FR;
the first threshold value is different from the second threshold value; and
the first FR is different from the second FR.

13. The UE of claim 8, wherein:
the corresponding threshold value comprises a first threshold value corresponding to bands in a first FR or a second threshold value corresponding to bands in a second FR;
the first threshold value is different from the second threshold value; and
the first FR is different from the second FR.

14. The UE of claim 8, wherein:
the processor is configured to determine that a second one of the first number, the second number, or the third number satisfies a corresponding second threshold value; and
the corresponding threshold value for the at least one of the first number, the second number, or the third number is different from the corresponding second threshold value for the second one of the first number, the second number, or the third number.

15. The UE of claim 8, wherein the processor is configured to identify that a plurality of bands associated with a first FR are configured based at least in part on the one or more NR CA or MR-DC configurations for the UE.

16. The UE of claim 15, wherein the processor is configured to determine that the at least one of the first number, the second number, or the third number satisfies the corresponding threshold value is configured to determine that at least one of the first number or the second number satisfies the corresponding threshold value.

17. The UE of claim 8, wherein the second indication for the gap measurement exception associated with the per-FR measurement gap configuration is based at least in part on the corresponding threshold value being satisfied.

18. The UE of claim 8, wherein the second indication for the gap measurement exception associated with the per-FR measurement gap configuration is based at least in part on a number of baseband resources being used by the UE.

19. A user equipment (UE), comprising:
one or more transceivers; and
a processor configured to,
transmit, via the one or more transceivers, a first indication that the UE is capable of supporting per-frequency range (FR) measurement gap configurations;
receive, via the one or more transceivers, a first configuration for a carrier in a millimeter wave FR;
receive, via the one or more transceivers, a second configuration for a measurement object; and
transmit, via the one or more transceivers, a second indication for a gap measurement exception associated with the per-FR measurement gap configuration based at least in part on the reception of the first configuration and the second configuration.

20. The UE of claim 19, wherein the millimeter wave FR corresponds to a FR of 52.6-71 GHz.
